(19) United States
(12) Patent Application Publication
(10) Pub. No.: US 2014/0366829 A1
(43) Pub. Date: Dec. 18, 2014

(54) STARTER PROTECTOR HAVING DELAY CIRCUIT, DELAY CIRCUIT THEREOF AND MOBILE VEHICLE

(71) Applicants: UNIVERSAL SCIENTIFIC INDUSTRIAL ( SHANGHAI ) CO., LTD., Shanghai (CN); UNIVERSAL GLOBAL SCIENTIFIC INDUSTRIAL CO., LTD., Nantou County (TW)

(72) Inventor: HSIN-HUNG WU, NAN-TOU (TW)

(73) Assignees: UNIVERSAL SCIENTIFIC INDUSTRIAL ( SHANGHAI ) CO., LTD., Shanghai (CN); UNIVERSAL GLOBAL SCIENTIFIC INDUSTRIAL CO., LTD., Nantou County (TW)

(21) Appl. No.: 14/261,052

(22) Filed: Apr. 24, 2014

(30) Foreign Application Priority Data
Jun. 13, 2013 (TW) 102120886

(51) Int. Cl. H02H 7/20

(52) U.S. Cl. CPC H02H 7/20
USPC 123/179.3; 327/261; 327/288; 327/285

(57) ABSTRACT

A delay circuit is coupled to an electromagnetic coil and includes a power input end coupled to a first end of the electromagnetic coil, a first switch module coupled to the power input end, a second switch module coupled to a second end of the electromagnetic coil, a first timing module coupled to the power input end and the first switch module, and a second timing module coupled to the power input end and the second switch module. The second switch module turns on when the power input end supplies power. The first timing module is configured to count time when the power input end supplies power and turns on the first switch module after a first predetermined time. The second timing module is configured to count time after the first switch module turns on and turns on the second switch module after a second predetermined time.

### BACKGROUND

1. Technical Field

The present disclosure relates to a delay circuit, in particular, to a delay circuit for using in a starter protector of a mobile vehicle.

2. Description of Related Art

Referring to FIG. 1, which shows a functional block diagram illustrating a starter system in a conventional mobile vehicle. The mobile vehicle, such as an automobile. The starter system in the conventional mobile vehicle comprises a relay 12′, a starter switch 2 (i.e., an ignition switch, an electric switch, or a key-switch), a starter 3 (i.e., a motor), a battery 4, an engine 5, and an alternator 6. The relay 12′ is coupled between one end of the starter switch 2 and the starter 3. The battery 4 is coupled to another end of the starter switch 2, the relay 12′, the starter 3, and the alternator 6, respectively. The starter 3 is further coupled to the alternator 6 through the engine 5.

In the process of starting a mobile vehicle, the starter switch 2 first needs to be turned on so that the battery 4 can supply power to the relay 12′ exciting an electromagnetic coil (not shown in the FIG. 1) in the relay 12′ to generate electromagnetic effect and turn on the relay 12′. When the relay 12′ is turned on, the power supplied by the battery 4 energizes the starter 3 through an electromagnetic switch (not shown in the FIG. 1) in the starter 3. The starter 3 then operatively drives the engine 5 and the alternator 6 to operate, and the starter 3 will be turned off when the engine 5 and the alternator 6 have been successfully driven in operation so as to complete the starting process for the mobile vehicle.

During the process of turning off the starter 3, the electric field of electromagnetic coil in the relay 12′ generally is de-energized as the starter switch 2 cuts off and causes the starter 3 to turn off. However, when the starter switch 2 cannot be turned off normally or an normally open contact of the relay 12′ is shorted or interrupted due to long-term usage or oxidization, the battery 4 continue to keep supplying power to the starter 3 and eventually causes the relay 12′ or the starter 3 to be burned or malfunctioned. As a result, the starter 3 is unable to operate during the starting process of the mobile vehicle.

### SUMMARY

A starter protector with a delay circuit and a vehicle thereof are provided in the present disclosure. In which, a starter can automatically turn off within a predetermined time after being initiated by controlling the on/off sequences of two switch modules so as to prevent the relay and the starter from overheated or burned.

An exemplary embodiment of the present disclosure provides a delay circuit. The delay circuit is coupled to an electromagnetic coil. The delay circuit comprises a power input end coupled to the electromagnetic coil, a first switch module coupled between the power input end and a ground, a second switch module coupled between the electromagnetic coil and the ground, a first timing module coupled between the power input end and the ground, and a second timing module coupled between the power input end and the ground. The second switch module operatively turns on when the power input end supplies power. The first timing module is configured to count time when the power input end supplies power and turns on the first switch module after a first predetermined time. The second timing module is configured to count time after the first switch module is turned on and turn off the second switch module after a second predetermined time.

An exemplary embodiment of the present disclosure provides a starter protector. The starter protector is coupled between a starter switch and a starter. The starter protector comprises a relay and the aforementioned delay circuit coupled to the relay. A power input end is coupled between the relay and the starter witch, and is configured to supply power when the starter switch turns on and stop supply power when the starter switch is turned off. A second switch module is turned on to energize the starter when the power input end supplies power. A first timing module is configured to count time when the power input end supplies power and to turn on the first switch module after the first predetermined time. A second timing module is configured to count time after the first switch module is turned on and to turn off the second switch module after the second predetermined time.

An exemplary embodiment of the present disclosure provides a mobile vehicle having a starter protector and a delay circuit thereof. The mobile vehicle comprises the aforementioned starter protector, the starter switch, the starter, the battery, the engine, and the alternator. The starter protector comprises the aforementioned delay circuit which is coupled between the starter switch and the starter. When the second switch module in the delay circuit is turned on to energize the starter, sequentially causes the first timing module to count the first predetermined time and the second timing module to count the second predetermined time. The second switch module is further turned off after the second timing module counts up to the second predetermined time counted to ensure that the relay and the starter are turned off. So that damage to the relay and the starter caused by abnormal operation of the starter switch can be avoided, thereby prevent the mobile vehicle from burst into flame.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the scope of the present disclosure.

### BRIEF DESCRIPTION OF THE DRAWINGS

The accompanying drawings are included to provide a further understanding of the present disclosure, and are incorporated in and constitute a part of this specification.

FIG. 1 is a functional block diagram of a starter system in a conventional mobile vehicle.

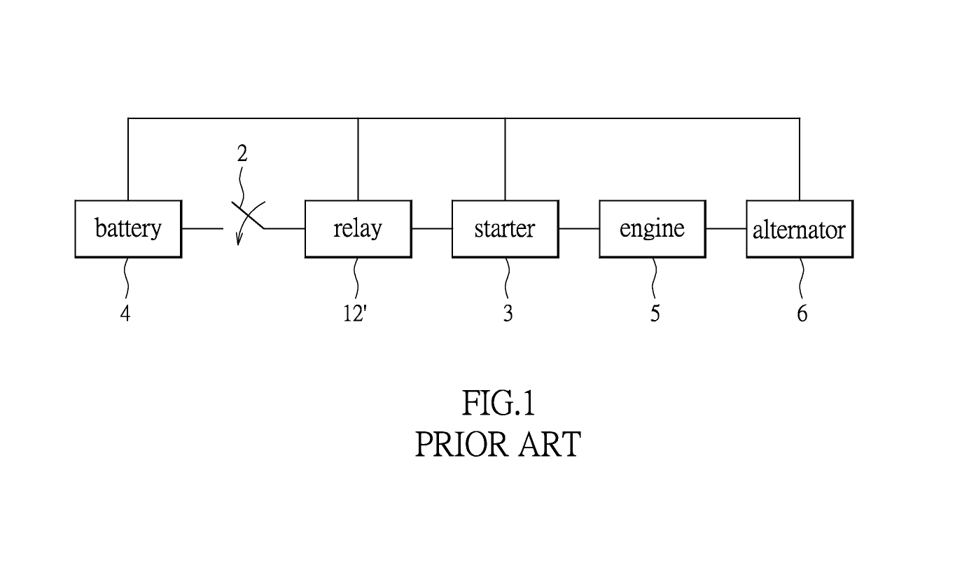

FIG. 2A is a functional block diagram of a mobile vehicle provided in accordance to an exemplary embodiment of the present disclosure.

FIG. 2B is a functional block diagram of a delay circuit provided in accordance to an exemplary embodiment of the present disclosure.

FIG. 3A is a detailed circuit diagram of a delay circuit provided in accordance to an exemplary embodiment of the present disclosure.

FIG. 3B is a detailed circuit diagram of a delay circuit provided in accordance to another exemplary embodiment of the present disclosure.

### DESCRIPTION OF THE EXEMPLARY EMBODIMENTS

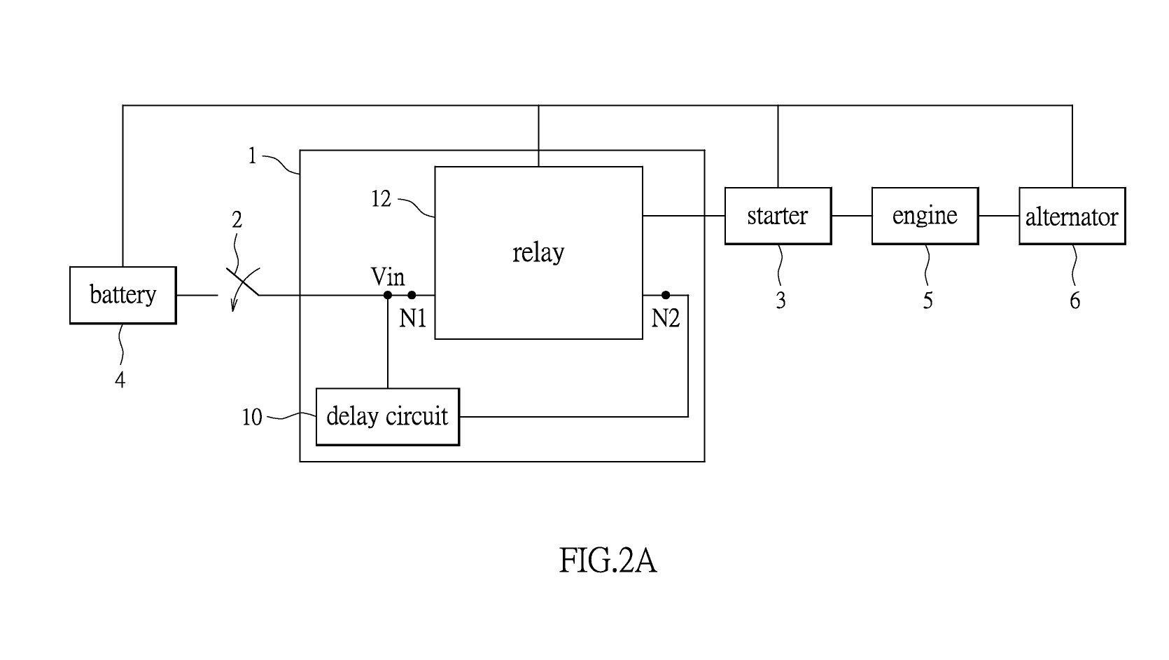

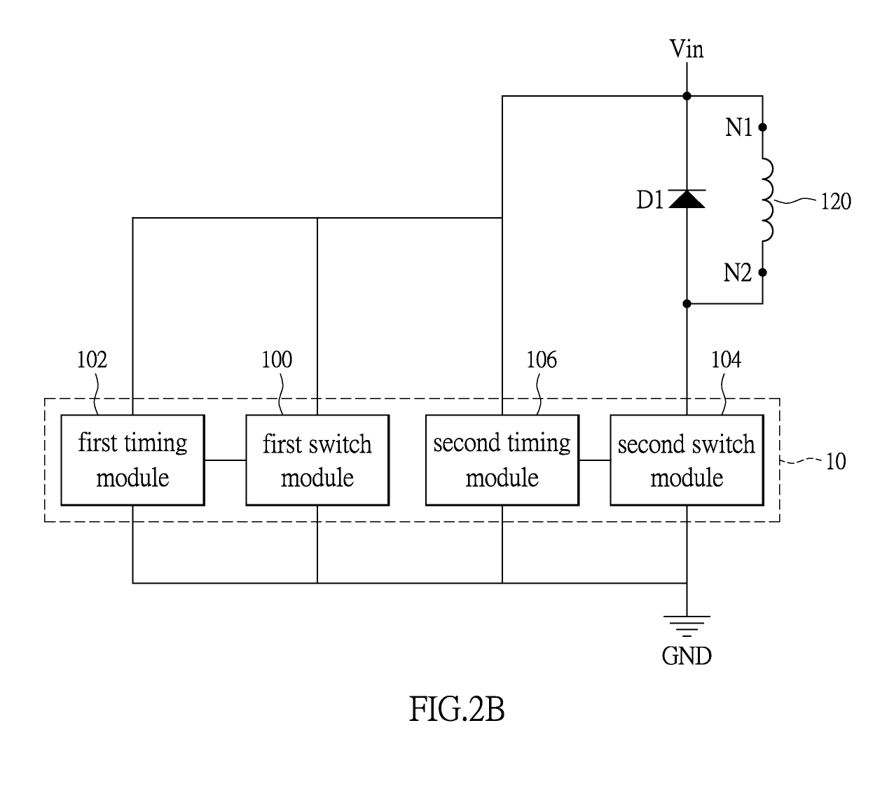

Referring to FIG. 2A and FIG. 2B at the same time. FIG. 2A is a functional block diagram illustrating a mobile vehicle provided in accordance to an exemplary embodiment of the present disclosure; FIG. 2B is a functional block diagram illustrating a delay circuit provided in accordance to an exemplary embodiment of the present disclosure. The mobile vehicle in the present embodiment includes a starter protector 1, a starter switch 2, a starter 3, a battery 4, an engine 5, and an alternator 6, respectively disposed on the mobile vehicle. Specifically, the starter protector 1 is coupled between the starter switch 2 and the starter 3. The related connections and the operations of the battery 4, the engine 5 and the alternator 6 are well known arts to those skilled in the art and hence further descriptions are hereby omitted.

The starter protector 1 includes a delay circuit 10 and a relay 12. The relay 12 has an electromagnetic coil 120 (refer to FIG. 2B) and a normally open contact (not shown). The first end N1 of the electromagnetic coil 120 is coupled to the starter switch 2. The delay circuit 10 is coupled to the first end N1 and the second end N2 of the electromagnetic coil 120. As the relay 12 has been widely used in the mobile vehicles and thus further descriptions are hereby omitted. Detail structure and operation of each functional module of the delay circuit 10 are respectively described in the following paragraphs.

As illustrated in FIG. 2B, the delay circuit 10 mainly includes a first switch module 100, a first timing module 102, a second switch module 104, and a second timing module 106. The power input end Vin of the delay circuit 10 is coupled between the first end Ni and the second end N2 of the electromagnetic coil 120. The power input end Vin is configured to supply power to the delay circuit 10 when the starter switch 2 turns on and stop to supply power to the delay circuit 10 when the starter switch turns off.

The first timing module 102 and the second timing module 106 are coupled in parallel between the power input end Vin and the ground GND. The first timing module 102 is configured to count time when a trigger event occurs and to generate a set of control signals after counting a period of predetermined time.

The first switch module 100 and the second switch module 104 include an input end, an output end, and a control end, respectively. The input end of the first switch module 100 is coupled to the power input end Vin. The output end of the first switch module 100 is coupled to a ground GND. The control end of the first switch module 100 is coupled to the first timing module 102. The input end of the second switch module 104 is coupled to the second end N2 of the electromagnetic coil 120. The output end of the second switch module 104 is coupled to the ground GND. The control end of the second switch module 104 is coupled to the second timing module 106. In practice, the second switch module 104 may be a metal oxide semiconductor field effect transistor (MOSFET) with a diode parallel connected thereto in inverse configuration. The control signal is the gate signal of the MOSFET with the diode parallel connected diode thereto in inverse configuration. The first switch module 100 may also be a MOSFET or a bipolar junction transistor (BJT) with a diode parallel connected thereto in inverse configuration.

In practical operation, the second switch module 104 turns on to energize the starter 3 when the power input end Vin supplies power. The first timing module 102 subsequently begins to count time when the power input end Vin supplies power and turns on the first switch module 100 after finish counting the first predetermined time. The second timing module 106 is configured to begin to count time when the first switch module 100 turns on and turns off the second switch module 104 after finish counting the second predetermined time. The first predetermined time in the present disclosure can be determined by the capacitance and the resistance of a resistor-capacitor series circuit (RC series circuit). Similarly, the second predetermined time in the present disclosure can be determined by the capacitance and the resistance of a resistor-capacitor parallel circuit (RC parallel circuit).

Accordingly, the starter protector 1 in the present disclosure can through triggering interactions among each functional module in the delay circuit 10 automatically cut off the second switch module 104 thereby avoid burning damage to the relay 12 and the starter 3. The counting period for the second switch module 104 from conduction to cut-off is the sum of the first predetermined time and the second predetermined time. The counting period from conduction to cut-off for the second switch module 104 is usually configured between 2-30 seconds, however, there present disclosure is not limited thereto. Those skilled in the art may determine reasonable first predetermined time and second predetermined time according to the operational requirements of the relay 12 and the starter 3.

The delay circuit 10 in the instant embodiment may further comprise a first diode D 1. An anode of the first diode D1 is coupled to the second switch module 104 and the second end N2 of the electromagnetic coil 120. A cathode of the first diode D1 is coupled to the power input end Vin. The first diode D1 is configured for consuming the inductive energy stored in the electromagnetic coil 120 when the second switch module 104 turns off.

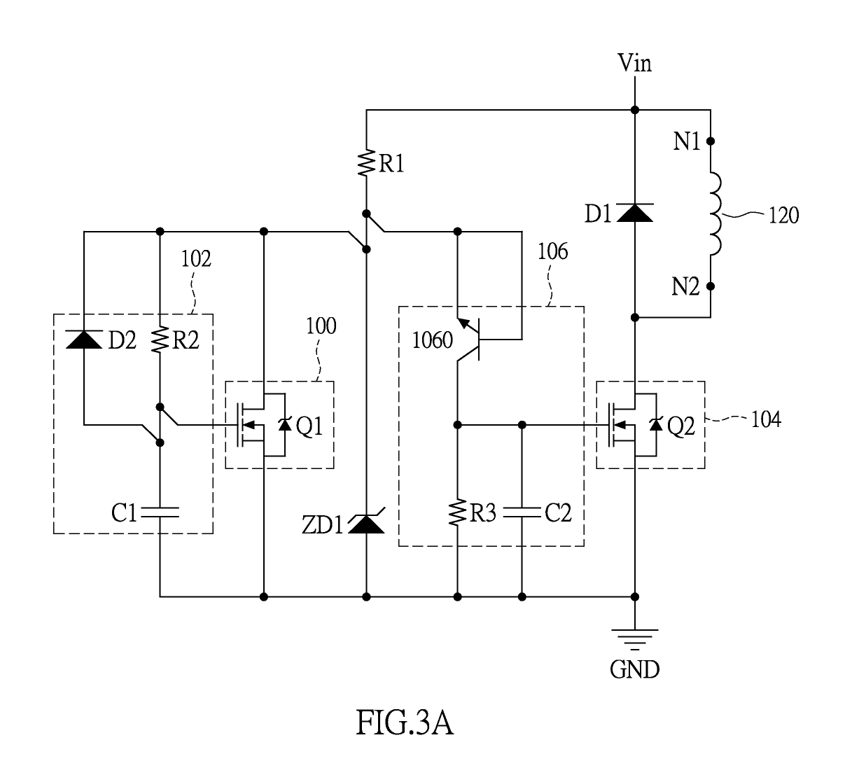

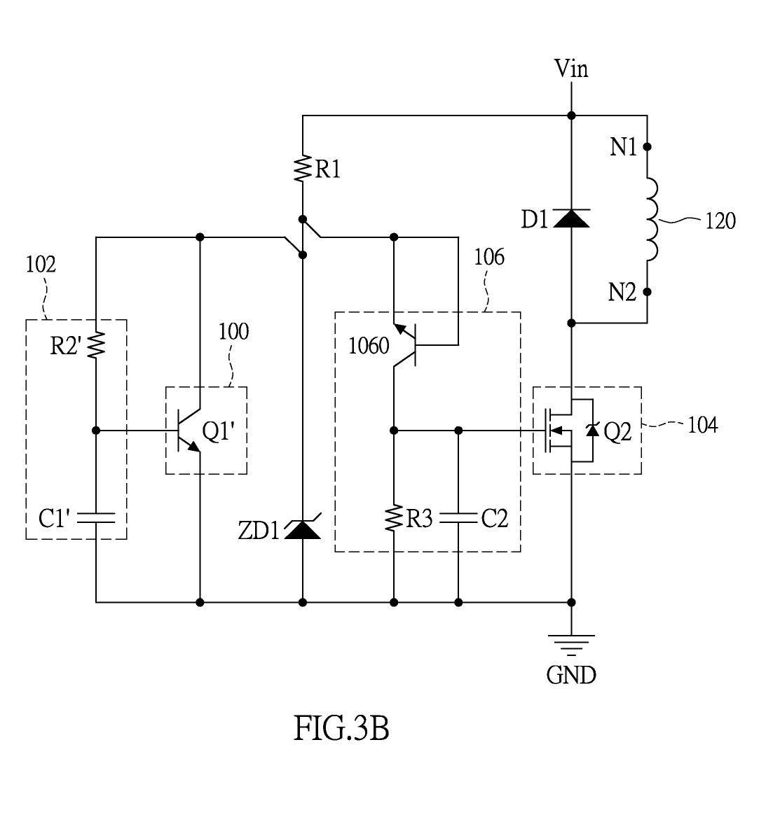

FIG. 3A is a detailed circuit diagram illustrating a delay circuit provided in accordance to an exemplary embodiment of the present disclosure. Referring to FIG. 3A, the first switch module 100 includes a MOSFET Q1. The first timing module 102 includes a combinational circuit of a RC series circuit and a second diode D2, wherein the RC series circuit includes a capacitor C1 and a resistor R2. A cathode of the second diode D2 is coupled to the resistor R2 end of the RC series circuit while an anode of the second diode D2 is coupled to the junction formed between the resistor R2 and the capacitor C1 of the RC series circuit. The drain of the MOSFET Q1, the cathode of the second diode D2, and the resistor R2 end of the RC series circuit are respectively coupled to the power input end Vin through the resistor R1. The source of the MOSFET Q1 and the capacitor C1 end of the RC series circuit are respectively coupled to the ground GND. The gate of the MOSFET Q1 is coupled to the junction formed between the resistor R2 and the capacitor C1 of the RC series circuit.

The second switch module 104 includes a MOSFET Q2. The second timing module 106 includes a combinational circuit of a forward bias element 1060 and a RC parallel circuit. The RC parallel circuit includes a capacitor C2 and a resistor R3. The drain of the MOSFET Q2 is coupled to the second end N2 of the electromagnetic coil 120. The source of the MOSFET Q2 is coupled to the ground GND. The gate of the MOSFET Q2 is coupled between the forward bias element 1060 and a RC parallel circuit. The input end of the forward bias element 1060 is coupled to the power input end Vin through the resistor R1. The output end of the forward bias element 1060 is coupled to the RC parallel circuit.

In the present embodiment, the forward bias element 1060 is a NPN BJT configured in a diode connection manner. The input end of the forward bias element 1060 is formed by having the emitter of the NPN BJT coupled to the base. The output end of the forward bias element 1060 is the collector. In another embodiment, the forward bias element 1060 may be implemented by a diode (not shown), wherein the input end of the forward bias element 1060 is an anode of the diode, and the output end of the forward bias element 1060 is a cathode of the diode.

The delay circuit 10 in the present embodiment may further include a zener diode ZD 1. A cathode of the zener diode ZD1 is coupled to the power input end Vin through the resistor R1. An anode of the zener diode ZD1 is coupled to the ground RND. The zener diode ZD1 is parallel connected to the first timing module 102, the first switch module 100, and the second timing module 106 for preventing burning damage to the MOSFET Q1 and the MOSFET Q2.

Under a normal operation of the aforementioned starter protector, the forward bias element 1060 conducts to charge the capacitor C2 of the RC parallel circuit of the second timing module 106 when the power input end Vin begins to supply power. The second switch module 104 (i.e., the MOSFET Q2) conducts when the capacitor C2 of the RC parallel circuit is fully charged. The capacitor C2 of the RC parallel circuit then begins to discharge through resistor R3 after the first switch module 100 turns on while the forward bias element 1060 is cuts-off. Moreover, when the cross voltage across the RC parallel circuit becomes less than a threshold voltage of the MOSFET Q2, the second switch module 104 (i.e., the MOSFET Q2) turns off.

In a scenario where the starter switch 2 becomes malfunctioned and unable to turn off during a normal operation, the capacitor C2 of the RC parallel circuit of the second timing module 106 will begin to discharge through the resistor R3 until the cross voltage across the RC parallel circuit becomes less than the threshold voltage of the MOSFET Q2 (i.e., after the second timing module 106 has finished counting the second predetermined time). At that time, the MOSFET Q2 cuts off to forcibly shut down the operations of the relay 12 and the starter 3 so as to prevent damage to the relay 12 and the starter 3 due to overheating.

The total time interval from conduction to cut-off for the MOSFET Q2 of the relay circuit 10 in FIG. 3A is equal to (R1+R2)×C1+R3×C2, wherein (R1+R2)×C1 represents the charging time of the capacitor C1 (i.e., the first predetermined time) while R3×C2 represents the discharging time of the capacitor C2 (i.e., the second predetermined time).

It shall be noted that the present disclosure does not limit the circuit implementation means for each functional module in the delay circuit 10. For example, the first switch module 100 may also be implemented by a BJT. FIG. 3B shows a detailed circuit diagram illustrating a delay circuit provided in accordance to another exemplary embodiment of the present disclosure. As illustrated in FIG. 3B, the first switch module 100 includes a BJT Q1′. The first timing module 102 includes a RC series circuit. The RC series circuit includes a capacitor Cr and a resistor R2′. The collector of the BJT Q1′ and the resistor R2′ end of the RC series circuit are respectively coupled to the power input end Vin. The emitter of the BJT Q1′ and the capacitor Cr end of the RC series circuit are respectively coupled to the ground GND. The base of the BJT Q1′ is coupled to a junction formed between the resistor R2′ and the capacitor C1′. In the instant embodiment, the first predetermined time represents the charging time of the capacitor C1′ which is equal to (R1+R2′)×C1′. The second predetermined time represents the discharging time of the capacitor C2 which is equal to R3×C2.

According to the above descriptions, exemplary embodiments of the present disclosure provide a starter protector adapted for a mobile vehicle, a delay circuit thereof and a mobile vehicle. When the second switch module in the delay circuit turns on to energize the starter, sequentially causes the first timing module to count the first predetermined time and the second timing module to count the second predetermined time. Moreover, after the second timing module finish counting to the second predetermined time the second switch module is turned off to ensure that the relay and the starter are turned off. So that the damage to the relay and the starter caused by abnormal operation of the starter switch can be avoided. Additionally, the delay circuit disclosed in the embodiments of the present disclosure may further determine the on/off operation sequence of the first switch module and the second switch module using transistor according to the charging/discharging characteristics of the RC circuit. Such that that the second switch module can automatically turn off within a predetermined time so as to protect the relay and the starter. Accordingly, the starter protector, the delay circuit thereof, a mobile vehicle disclosed in the present disclosure can effectively lower the risks for operation failure and burning damage to the relay and the starter by utilization of just few electronic components thereby reduce the overall manufacturing cost, hence are very practical in mobile vehicle industry.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A delay circuit coupled to a first end and a second end of an electromagnetic coil, comprising:
a power input end coupled to the first end of the electromagnetic coil;
a first switch module coupled to the power input end and a ground;
a second switch module coupled to the second end of the electromagnetic coil and the ground, and operatively turning on when the power input end supplies power;
a first timing module coupled to the power input end, a control end of the first switch module, and the ground, and configured to count time when the power input end supplies power and to turn on the first switch module after a first predetermined time; and
a second timing module coupled to the power input end, a control end of the second switch module, and the ground, and configured to count time after the first switch module is turned on and to turn off the second switch module after a second predetermined time.

2. The delay circuit as claimed in claim 1, wherein the first switch module is a metal oxide semiconductor field effect transistor (MOSFET), the first timing module comprising a combinational circuit of a RC series circuit and a diode, wherein a cathode of the diode is coupled to a resistor end of the RC series circuit, and an anode of the diode is coupled between a resistor and a capacitor of the RC series circuit, wherein a drain of the MOSFET, the cathode of the diode, and the resistor end of the RC series circuit are respectively coupled to the power input end, a source of the MOSFET and a capacitor end of the RC series circuit are respectively coupled to the ground, and a gate of the MOSFET is coupled between the resistor and the capacitor of the RC series circuit.

3. The delay circuit as claimed in claim 1, wherein the first switch module is a bipolar junction transistor (BJT) and the first timing module is a RC series circuit, a collector of the BJT and a resistor end of the RC series circuit respectively coupled to the power input end, an emitter of the BJT and a capacitor end of the RC series circuit respectively coupled to the ground, and a base of the BJT coupled between a resistor and a capacitor of the RC series circuit.

4. The delay circuit as claimed in claim 2, wherein the capacitor of the RC series circuit begins to charge as the power input end supplies power, and the first switch module turns on when the capacitor of the RC series circuit is charged to a saturation voltage.

5. The delay circuit as claimed in claim 3, wherein the capacitor of the RC series circuit begins to charge as the power input end supplies power, and the first switch module turns on when the capacitor of the RC series circuit is charged to a saturation voltage.

6. The delay circuit as claimed in claim 1, wherein the second switch module is a MOSFET, the second timing module comprising a combinational circuit of a forward bias element and a RC parallel circuit, a drain of the MOSFET coupled to the second end of the electromagnetic coil, a source of the MOSFET coupled to the ground, an input end of the forward bias element coupled to the power input end, an output end of the forward bias element coupled to the RC parallel circuit, a gate of the MOSFET coupled between the forward bias element and the RC parallel circuit.

7. The delay circuit as claimed in claim 6, wherein the MOSFET turns off when the voltage across the RC parallel circuit becomes less than a threshold voltage of the MOSFET.

8. A starter protector, being coupled between a starter switch and a starter, comprising:
a relay having an electromagnetic coil, a first end of the electromagnetic coil coupled to the starter switch; and
a delay circuit coupled to the first end and a second end of the electromagnetic coil, the delay circuit comprising:
a power input end coupled between the first end of the electromagnetic coil and the starter switch, the power input end configured to operatively supply power when the starter switch turns on and stop to supply power when the starter switch turns off;
a first switch module coupled to the power input end and a ground;
a second switch module coupled to the second end of the electromagnetic coil and the ground, and operatively turning on to drive the starter when the power input end supplies power;
a first timing module coupled to the power input end, a control end of the first switch module and the ground, and configured to count time when the power input end supplies power and to turn on the first switch module after a first predetermined time; and
a second timing module coupled to the power input end, a control end of the second switch module and the ground, and configured to count time after the first switch module is turned on and to turn off the second switch module after a second predetermined time.

9. The starter protector as claimed in claim 8, wherein the delay circuit further comprises a first diode having an anode thereof coupled between the second switch module and the second end of the electromagnetic coil, and a cathode thereof coupled to the power input end, wherein the first diode is configured to consume the inductive energy generated by the electromagnetic coil when the second switch module turns off.

10. The starter protector as claimed in claim 8, wherein the first switch module is a MOSFET, the first timing module comprising a combinational circuit of a RC series circuit and a second diode, wherein a cathode of the second diode is coupled to a resistor end of the RC series circuit, and an anode of the second diode is coupled between a resistor and a capacitor of the RC series circuit, wherein a drain of the MOSFET, the cathode of the second diode and the resistor end of the RC series circuit are respectively coupled to the power input end, a source of the MOSFET and a capacitor end of the RC series circuit are respectively coupled to the ground, and a gate of the MOSFET is coupled between the resistor and the capacitor of the RC series circuit.

11. The starter protector as claimed in claim 8, wherein the first switch module is a BJT, while the first timing module is a RC series circuit, a collector of the BJT and a resistor end of the RC series circuit being respectively coupled to the power input end, an emitter of the BJT and a capacitor end of the RC series circuit respectively coupled to the ground, and a base of the BJT coupled between a resistor and a capacitor of the RC series circuit.

12. The starter protector as claimed in claim 10, wherein the capacitor of the RC series circuit begins to charge when as power input end supplies power, and the first switch module turns on when the capacitor of the RC series circuit is charged to a saturation voltage.

13. The starter protector as claimed in claim 11, wherein the capacitor of the RC series circuit begins to charge as the power input end supplies power, and the first switch module turns on when the capacitor of the RC series circuit is charged to a saturation voltage.

14. The starter protector as claimed in claim 8, wherein the second switch module is a MOSFET, the second timing module comprising a combinational circuit of a forward bias element and a RC parallel circuit, a drain of the MOSFET coupled to the second end of the electromagnetic coil, a source of the MOSFET coupled to the ground, an input end of the forward bias element coupled to the power input end, an output end of the forward bias element coupled to the RC parallel circuit, and a gate of the MOSFET being coupled between the forward bias element and the RC parallel circuit.

15. The starter protector as claimed in claim 14, wherein the MOSFET turns off when the voltage across the RC parallel circuit becomes less than a threshold voltage of the MOSFET.

16. A mobile vehicle, comprising:
a battery disposed on the mobile vehicle;
an alternator disposed on the mobile vehicle, and coupled to the battery;
an engine coupled to the alternator;
a starter coupled to the engine and the battery;
a starter switch having a first end thereof coupled to the battery; and
a starter protector coupled between a second end of the starter switch and the starter, the starter protector further comprising:
a relay having an electromagnetic coil, a first end of the electromagnetic coil coupled to the second end of the starter switch; and
a delay circuit coupled to the first end and a second end of the electromagnetic coil, the delay circuit comprising:
a power input end coupled between the first end of the electromagnetic coil and the second end of the starter switch, and the power input end configured to operatively supply power when the starter switch turns on and stop to supply power when the starter switch turns off;
a first switch module coupled to the power input end and a ground;
a second switch module coupled to the second end of the electromagnetic coil and the ground, and operatively turning on to drive the starter when the power input end supplies power;
a first timing module coupled to the power input end, a control end of the first switch module and the ground, and configured to count time when the power input end supplies power and to turn on the first switch module after a first predetermined time; and
a second timing module coupled to the power input end, a control end of the second switch module and the ground, and being configured to count time after the first switch module is turned on and to turn off the second switch module after a second predetermined time.

17. The mobile vehicle as claimed in claim 16, wherein the delay circuit further comprises a first diode, having an anode thereof coupled between the second switch module and the second end of the electromagnetic coil, and a cathode thereof coupled to the power input end, wherein the first diode is configured to consume the inductive energy generated by the electromagnetic coil when the second switch module turns off.

18. The mobile vehicle as claimed in claim 16, wherein the first switch module is a MOSFET, the first timing module comprising a combinational circuit of a RC series circuit and a second diode, wherein a cathode of the second diode is coupled to a resistor end of the RC series circuit, and an anode of the second diode is coupled between a resistor and a capacitor of the RC series circuit, wherein a drain of the MOSFET, the cathode of the second diode and the resistor end of the RC series circuit are respectively coupled to the power input end, a source of the MOSFET and a capacitor end of the RC series circuit are respectively coupled to the ground, and a gate of the MOSFET is coupled between the resistor and the capacitor of the RC series circuit.

19. The mobile vehicle as claimed in claim 16, wherein the second switch module is a MOSFET, the second timing module comprising a combinational circuit of a forward bias element and a RC parallel circuit, a drain of the MOSFET coupled to the second end of the electromagnetic coil, a source of the MOSFET coupled to the ground, an input end of the forward bias element coupled to the power input end, an output end of the forward bias element coupled to the RC parallel circuit, a gate of the MOSFET coupled between the forward bias element and the RC parallel circuit.

20. The mobile vehicle as claimed in claim 19, wherein the MOSFET turns off when the voltage across the RC parallel circuit becomes less than a threshold voltage of the MOSFET.
